(19) United States
(12) Patent Application Publication
(10) Pub. No.: US 2020/0386392 A1
(43) Pub. Date: Dec. 10, 2020

(54) HEAT EXCHANGE ARRANGEMENT FOR LIGHT EMITTING DIODE LAMP MODULES

(71) Applicant: APPLIED Materials, Inc., Santa Clara, CA (US)

(72) Inventors: Robert B. Vopat, Austin, TX (US); Jason M. Schaller, Austin, TX (US); Mitchell DiSanto, Georgetown, TX (US)

(73) Assignee: APPLIED Materials, Inc., Santa Clara, CA (US)

(21) Appl. No.: 16/436,283

(22) Filed: Jun. 10, 2019

(51) Int. Cl. F21V 29/503; F21V 29/56; F21V 29/83; F21V 29/508

(52) U.S. Cl. CPC F21V 29/503; F21V 29/56; F21Y 2115/10; F21V 29/508; F21V 29/83

(57) ABSTRACT

A heat exchange arrangement for a light emitting diode (LED) lamp module includes a base portion and a printed circuit board (PCB) portion. The base portion has first and second surfaces, the first surface comprising a plurality of channels. The PCB portion has first and second surfaces, the first surface configured to receive a plurality of LEDs thereon. The second surface of the PCB portion is coupled to the first surface of the base portion. The first surface of the base portion includes a plurality of open channels disposed therein, and the second surface of the PCB portion encloses said plurality of channels when the PCB portion is coupled to the base portion. The plurality of channels form cooling channels forming watertight passages for coolant fluid to flow through.

### FIELD

This disclosure relates to substrate processing. More particularly, the present disclosure relates to improved temperature management systems and methods for use in substrate processing.

### BACKGROUND

Several applications that involve the thermal processing of substrates such as semiconductor substrates and other materials involve the process steps of rapidly heating and cooling a substrate. Examples of such processing include rapid thermal processing (RTP), physical vapor deposition (PVD) processing, and the like, which are used for various semiconductor fabrication processes.

During semiconductor fabrication processing, heat energy from lamps is radiated into the process chamber and onto a semiconductor substrate in the processing chamber. In this manner, the substrate is heated to a specific processing temperature. Conventional lamps (tungsten-halogen, mercury vapor, arc discharge) or electrical heating elements have been used to deliver energy to the substrate for dopant annealing, film deposition, or film modification. These processes are often thermally based and typically use high process temperatures ranging from 200-degrees Celsius (C.) to 1600-degrees C., which can result in significant thermal budget issues that adversely affect device performance.

As an alternative to conventional lamps, arrays of solid-state light sources, for example Light Emitting Diodes (LEDs), may be used for various semiconductor fabrication processes. Some LED lamp modules can include several thousand LEDs and can produce more than 20 kilowatts of heat energy. Removing such heat is important to the function of the LED lamp module because luminous efficacy decreases as temperature increases. As will be appreciated, less power output can result in reduced substrate heating capability.

With respect to these and other considerations the present disclosure is provided.

### SUMMARY OF THE DISCLOSURE

In view of the foregoing, a heat exchange arrangement for a light emitting diode (LED) lamp module includes a base portion having first and second surfaces, the first surface comprising a plurality of open channels disposed thereon, and a printed circuit board (PCB) portion having first and second surfaces, the first surface of the PCB configured to receive a plurality of LEDs thereon, the second surface of the PCB portion configured to be coupled to the first surface of the base portion. The second surface of the PCB portion may enclose said plurality of open channels when the PCB portion is coupled to the base portion to form a plurality of cooling channels therebetween.

A method of making a heat exchange arrangement for a light emitting diode (LED) lamp module includes: providing a base portion having first and second surfaces, the first surface comprising a plurality of open channels disposed thereon; providing a printed circuit board (PCB) portion having first and second surfaces, the first surface of the PCB configured to receive a plurality of LEDs thereon, the second surface of the PCB portion configured to be coupled to the first surface of the base portion; and soldering the PCB portion to the base portion so that the second surface of the PCB portion encloses said plurality of open channels to form a plurality of cooling channels between the PCB portion and the base portion.

A system for removing heat from a light emitting diode (LED) lamp module includes a base portion having first and second surfaces, the first surface comprising a plurality of open channels disposed thereon; and a printed circuit board (PCB) portion having first and second surfaces, the first surface of the PCB having a plurality of LEDs coupled thereto, the second surface of the PCB portion configured to be coupled to the first surface of the base portion. The second surface of the PCB portion is soldered to the base portion to encloses said plurality of open channels, thereby forming a plurality of cooling channels therebetween, the plurality of cooling channels comprising watertight passages for a coolant fluid to flow through.

### BRIEF DESCRIPTION OF THE DRAWINGS

FIG. 1 is a schematic view of an exemplary system for heating a substrate in accordance with embodiments of the disclosure;

FIG. 2 is an isometric view of an exemplary LED energy source in accordance with embodiments of the disclosure;

FIG. 3 is an isometric view of an arrangement for cooling an LED energy source in accordance with embodiments of the disclosure;

FIG. 4 depicts an exploded view of the arrangement of FIG. 3;

FIG. 5 is a cross-section view, taken along line 5-5 of FIG. 3;

FIG. 6 is a detail view of a portion of the cross-section view of FIG. 5; and

FIG. 7 is a logic flow according to an embodiment of the disclosure.

### DETAILED DESCRIPTION

The present embodiments will now be described more fully hereinafter with reference to the accompanying drawings, in which various embodiments are shown. The subject of this disclosure, however, may be embodied in many different forms and should not be construed as limited to the embodiments set forth herein. Rather, these embodiments are provided so that this disclosure will be thorough and complete, and will fully convey the scope of the subject of this disclosure to those skilled in the art. In the drawings, like numbers refer to like elements throughout.

In the following description and/or claims, the terms “on,” “overlying,” “disposed on” and “over” may be used in the following description and claims. “On,” “overlying,” “disposed on” and “over” may be used to indicate that two or more elements are in direct physical contact with each other. However, “on,”, “overlying,” “disposed on,” and over, may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

The disclosure describes an improved arrangement and a method for assembling a metal-based printed circuit board (PCB) to a heat exchanger. In various embodiments the PCB may have a plurality of LEDs mounted thereto, and the arrangement and method can facilitate the removal of heat from the LEDs during operation.

In some conventional arrangements it is common to couple a heat generating surfaces to heat removal surfaces using thermal grease, thermal stickers, and metal foils between the metal PCB and heat exchanger. Such thermal interface compounds (TIM or TIC) range in thermal conductivity from <1 to 4 Watts/meter-Kelvin and can result in a significant thermal barrier to heat transfer between surfaces. In addition, where thermal grease is used the layers must be a thin as possible while also ensuring that there are no bare spots where the thermal compound is not present. Soldering a large heat generating surface to a large surface area flat heat exchanger eliminates some problems relating to thermal grease but can results in inconstant contact between the surfaces because the area is too large for excess flux to escape. This can result in the formation of air pockets between the heat generating surface and the heat exchanger, which can cause a thermal runaway condition to occur as the metal expands.

The disclosure provides and method and arrangement for directly soldering a metal PCB to a heat exchanger without the creation of trapped air pockets or other defects that can adversely impact heat transfer between a metal PCB and a heat exchanger. The disclosed method and arrangement improve thermal conductance between the PCB and the heat exchanger compared to conventional methods and arrangements.

In one embodiment, a plurality of LEDs can be coupled to a metal PCB portion. The PCB portion can be made from aluminum, copper, copper-plated aluminum. Copper traces can be directly deposited on a first surface of the PCB portion for coupling the plurality of LEDs thereto. A second surface of the metal PCB portion can be soldered directly on top of a base portion. In some embodiments the base portion has a plurality of open channels machined into a surface thereof. The second surface of the metal PCB portion can be placed onto the base portion, and the two can be soldered together to create a plurality of watertight channels through which coolant fluid can be passed. The result is a heat exchange arrangement in which coolant fluid can directly contact and cool the PCB portion. Since the solder connections between the base and PCB portions are limited to those discrete portions of the base and PCB portion that lie between adjacent channels, the total surface area required to be soldered is minimized. This, in turn, ensures that solid solder layers are formed between the PCB portion and the base portion.

In one embodiment, the soldering process used to couple the PCB portion to the heat exchanger is a low-temperature process (e.g., less than about 150-degrees C.). Employing such a low-temperature soldering process ensures that the connections between the PCB portion and the LEDs coupled to the surface thereof remain unaffected by the process of coupling the PCB portion to the heat exchanger. Thus, in one embodiment the LEDs are soldered to a first surface of the metal PCB portion. During this process the solder temperatures are kept in the range of about 220-250 degrees C. Once the LEDs have been soldered to the PCB portion, the PCB portion can be soldered to the heat exchanger using solder temperatures of below about 150-degrees C. so as not to disturb/damage the solder connections between the LEDs and the PCB portion.

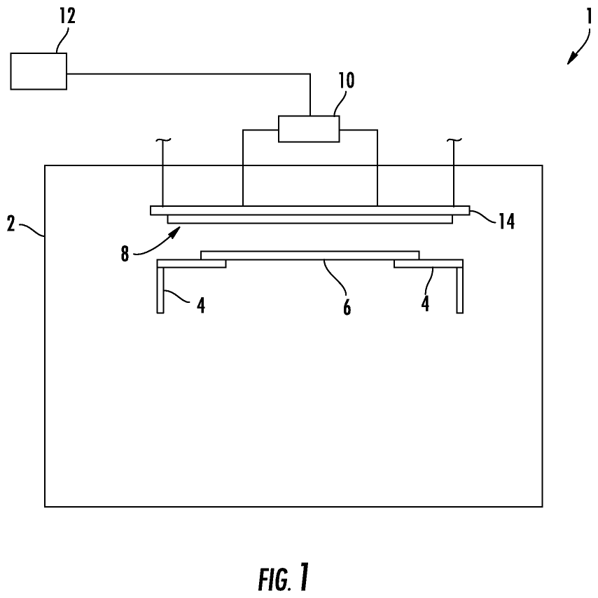

FIG. 1 is a schematic representation of an exemplary process chamber 1 for thermal processing, such as a rapid thermal process (RTP), and is suitable for use with the disclosed LED arrangement for heating substrates in accordance with embodiments of the present disclosure. The process chamber 1 may be any type of process chamber having an appropriate substrate support configured to support a substrate. Suitable process chambers that may utilize the inventive LED source for heating substrates described herein include Physical Vapor Deposition (PVD) chambers, Chemical Vapor Deposition (CVD) chambers, Epitaxial Deposition chambers, etch chambers, Atomic Layer Deposition (ALD) chambers, and the like.

The process chamber 1 may include a chamber body 2, a substrate support 4 for supporting a substrate 6 thereon, and an LED energy source 8, which may include a plurality of LEDs or array(s) of LEDs. It will be appreciated that the process chamber 1 depicted in FIG. 1 is illustrative only and other process chambers, including those configured for processes other than RTP, may be modified in accordance with the teachings provided herein.

In the illustrated embodiment, the LED energy source 8 is disposed above the substrate 6 for heating an upper surface of the substrate. The LED energy source 8 is coupled to one or more power sources 10 which may be coupled to controller 12 to control the LED energy source 8. In addition, a cooling arrangement may be used to cool the LED energy source 8. As will be described in greater detail later, the cooling arrangement may be configured to actively cool a backside of the LED energy source 8.

During processing, the substrate 6 can be disposed on the substrate support 4. As mentioned, the LED energy source 8 may generate a pre-determined temperature distribution across the substrate 6. In embodiments, where the heat source includes LEDs, the LED energy source 8 provides heat radiation that is absorbed by the substrate 6.

In some embodiments, LED energy source 8 may be used in conjunction with processing chambers to form films, treat dopants, change process gases (e.g., break bonds), and reorder the substrate itself. Additional high temperature substrate processing may benefit from LED heating as even higher output intensities become available. LEDs offer advantages when used, to process the near surface region of a substrate. LEDs last a long time and allow the output intensity to be chosen independent from the wavelength(s) of the output illumination. Light emitting diodes (LEDs) may consist of gallium nitride, aluminum nitride, combinations thereof or other III-V materials grown on a substrate constructed to emit light close to one or more wavelengths determined by the bandgap of III-V materials in the active region.

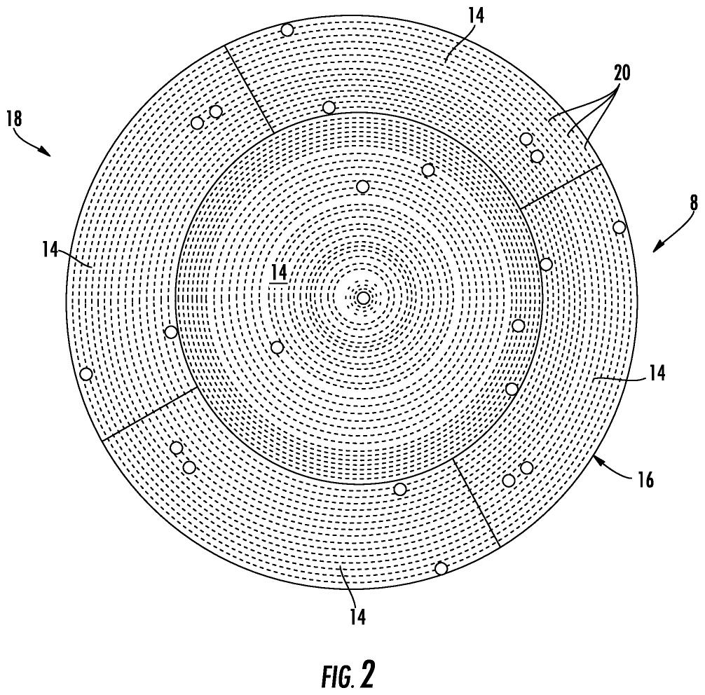

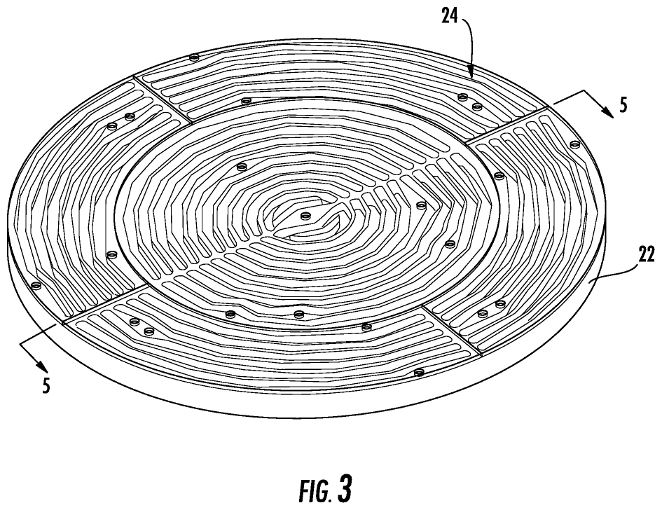

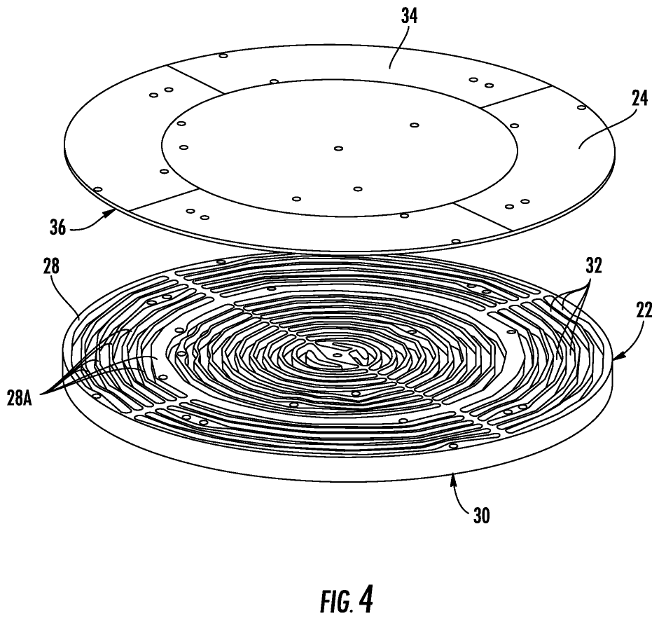

FIG. 2 shows an exemplary embodiment of an LED energy source 8 that includes a plurality of LED arrays 14 disposed on one or more Printed Circuit Board portions (PCBs) 16. An LED assembly 18, which can include the plurality of LED arrays 14 and associated PCB portions 16 can include multiple layers and structural elements as will be described in more detail below in relation to FIGS. 3-5.

As will be appreciated, each LED array 14 may contain between about 50 to about 500 LEDs 20. With sufficiently high packing densities of LEDs 20 over a given area, the LED arrays 14 can provide the ability to achieve rapid thermal processing. In some embodiments each LED 20 may be individually mounted on a metal PCB portion 16. In some embodiments, each LED 20 is mounted to the metal PCB portion using a soldering technique.

Referring now to FIGS. 3-6, an arrangement for cooling one or more LED arrays 14 will be described in greater detail. The arrangement may include a base portion 22 and a printed circuit board (PCB) portion 24 coupled together to form a plurality of cooling channels 26 therebetween. In the illustrated embodiment the base portion 22 and the PCB portion 24 have a circular shape, although this is not critical, and other shapes may be used.

The base portion 22 may have first and second surfaces 28, 30, with the first surface 28 including a plurality of open channels 32. In one embodiment, the plurality of open channels 32 are machined into the base portion 22, though other formation techniques (e.g., casting) can also be used.

The PCB portion 24 can have first and second surfaces 34, 36. The first surface 34 may be configured to receive a plurality of LEDs 20 (FIG. 2) thereon (e.g., the LEDs may be soldered to the first surface). The second surface 36 of the PCB portion may be configured to be coupled to the first surface 28 of the base portion 22. Thus, the second surface 34 of the PCB portion 24 may be generally planar, and may be configured to engage the first surface 28 of the base portion 22 so that the second surface of the PCB portion encloses the plurality of open channels 32 formed in the base portion when the PCB portion is coupled to the base portion. The second surface 34 of the PCB portion 24 may be coupled to the first surface 28 of the base portion 22 by soldering so that a plurality of cooling channels 26 are formed by the first surface 28 of the base portion, the plurality of open channels 32, and the second surface of the PCB portion.

In some embodiments the plurality of cooling channels 26 may comprise watertight passages for coolant fluid to flow through. The plurality of cooling channels 26 may be coupled together and may be coupled to a respective plurality of coolant fluid inlets (not shown) and coolant fluid outlets (not shown) to allow coolant fluid to be passed through the cooling channels. The coolant fluid inlets and outlets can be connected to an appropriate source of cooling fluid, including a coolant pump and external heat exchanger as desired.

In some embodiments the coolant fluid can comprise process cooling water that, in one non-limiting example embodiment, can be in the range of about 17-30 degrees C. Copper does not corrode when exposed to process cooling water, although Aluminum can. In some embodiments a heat exchanger or thermo chiller can be used in a cooling loop coupled to the coolant fluid inlets and coolant fluid outlets to set the temperature of the coolant at any desired value (e.g., 15 degrees C. or less). Such an arrangement could allow the use of Aluminum in the base portion and PCB portion without undue concern for corrosion. Examples of appropriate coolant fluids include deionized water, mixtures of deionized water and glycol, perfluorinated inert polyether fluids, and the like.

The plurality of cooling channels 26 are shown as being arc-shaped when viewed from above, though this is not critical and other shapes can be used. In some embodiments the plurality of cooling channels 26 are arranged to follow the pattern of heating zones in the LED arrays 14 so that consistent temperature is maintained in the arrays. This, in turn, can ensure consistent output within each zone, resulting in uniform heating.

The plurality of cooling channels 26 are shown as having a square cross-sectional shape (FIGS. 5 & 6), though it will be appreciated that other cross-sectional shapes can be used. In some embodiments the cooling channels 26 are configured so that the flow of coolant fluid is turbulent during operation.

As will be appreciated, coolant flowing through the plurality of cooling channels 26 directly contacts the second surface 36 of the PCB portion 24. In operation, the LEDs 20 of the LED arrays 14 generate heat, which is conducted to the PCB portion 24. Coolant flowing through the plurality of cooling channels 26 contacts the second surface 36 of the PCB portion 24, thus providing a heat removal path for heat generated by the plurality of LEDs 20 during operation.

As previously mentioned, the PCB portion 24 can comprise a metal plate, which in some embodiments can be copper, aluminum, or combinations thereof. The PCB portion 24 may be coupled to the base portion 22 by a soldering technique. In some embodiments the solder can be a low temperature solder applied between the PCB portion and the base portion at a temperature of about 150 degrees C. or less.

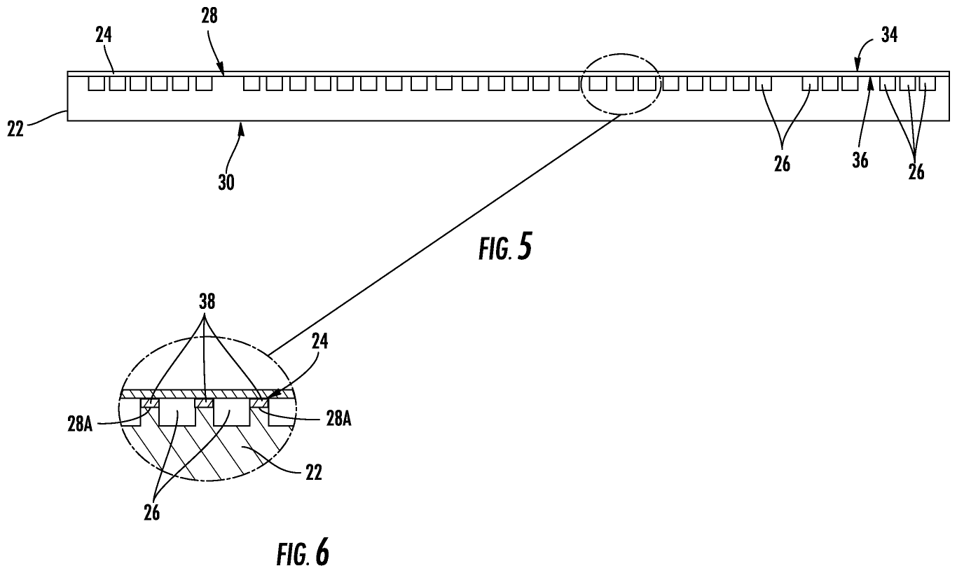

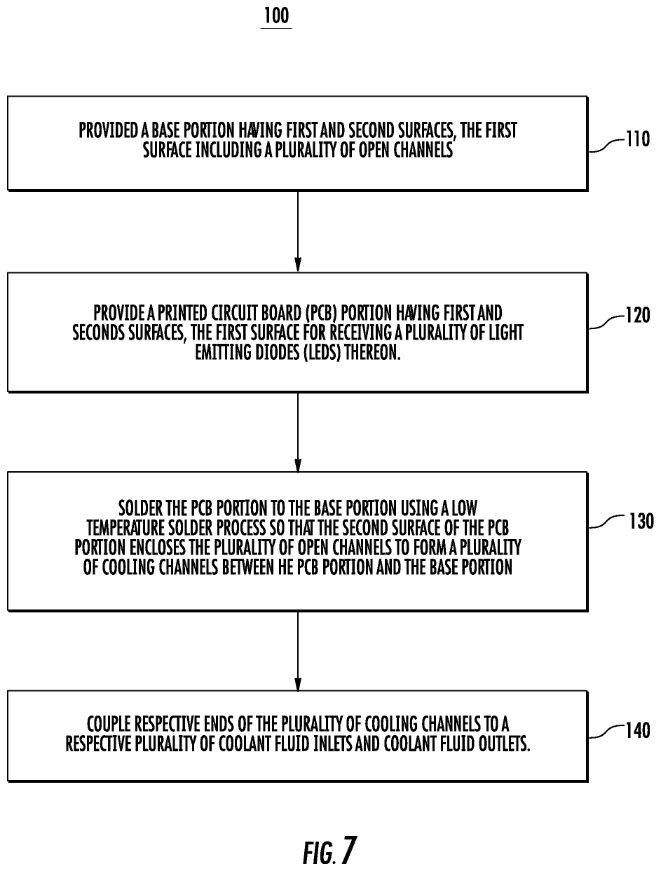

As shown in FIG. 6, once the PCB portion 24 is coupled to the base portion 22, solder layers 38 are disposed between the first surface 28 of the base portion 22 and the second surface 36 of the PCB portion. Providing channels in the base portion reduces the total amount of metal contact between the PCB portion 24 and the base portion 22. Thus, and as can be seen, the solder layers 38 do not cover the open channels 32, but rather are disposed only on the intermediate surface portions 28A of the first surfaces 28 of the base portion 22 which are disposed between the open channels. This results in a high integrity solder connection between the PCB portion and the base portion that minimizes or eliminates defects in the solder joints. During the soldering operation, excess solder and flux can evacuate into (and out of) the cooling channels 26, instead of causing defects in the coupling layer which can occur when soldering large planar surfaces.

Since the cooling fluid now comes into direct contact with the metal PCB, cooling efficiency is increased. In addition, a high thermally conductive joint between the metal PCB and heat exchanger exists through which heat can be transferred by conduction. In some embodiments about 90% of the PCB portion is directly exposed to coolant water flow, with the remaining 10% metal-solder-metal contact facilitating conductive cooling of the PCB portion.

Referring now to FIG. 7, and exemplary logic flow 100 according to the present disclosure will be described. At 110, a base portion is provided, the base portion having first and second surfaces, the first surface comprising a plurality of open channels disposed thereon. At 120, a PCB portion is provided, the PCB portion having first and second surfaces, the first surface of the PCB configured to receive a plurality of LEDs thereon. At 130 the PCB portion is soldered to the base portion so that the second surface of the PCB portion encloses said plurality of open channels to form a plurality of cooling channels between the PCB portion and the base portion. In one embodiment the PCB portion is soldered to the base portion using a low temperature soldering process, where the temperature is less than about 150 degrees C. At 140 respective ends of the plurality of cooling channels are coupled to a respective plurality of coolant fluid inlets and coolant fluid outlets for passage of coolant fluid therethrough.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

1. A heat exchange arrangement for a light emitting diode (LED) lamp module, comprising:
a base portion having first and second surfaces, the first surface comprising a plurality of open channels disposed thereon; and
a printed circuit board (PCB) portion having first and second surfaces, the first surface of the PCB having a plurality of LED arrays disposed thereon, the plurality of LED arrays forming a plurality of concentric arc-shaped LED arrays, the second surface of the PCB portion configured to be coupled to the first surface of the base portion;
wherein the second surface of the PCB portion encloses said plurality of open channels when the PCB portion is coupled to the base portion to form a plurality of cooling channels therebetween; and
wherein the plurality of cooling channels are arc-shaped when viewed from above to conform to the plurality of concentric shaped LED arrays to follow a pattern of heating zones in the plurality of LED arrays so that consistent temperature is maintained in the plurality of LED arrays.

2. The heat exchange arrangement of claim 1, wherein the plurality of cooling channels comprise watertight passages for coolant fluid to flow through.

3. The heat exchange arrangement of claim 1, wherein the plurality of cooling channels are coupled to a respective plurality of coolant fluid inlets and coolant fluid outlets for passage of coolant fluid therethrough.

4. The heat exchange arrangement of claim 1, wherein the PCB portion comprises a metal plate.

5. The heat exchange arrangement of claim 4, wherein the metal plate is made from copper, aluminum, or combinations thereof.

6. The heat exchange arrangement of claim 1, wherein the plurality of open channels are machined into the base portion.

7. The heat exchange arrangement of claim 1, wherein the PCB portion is coupled to the base portion by solder.

8. The heat exchange arrangement of claim 7, wherein the solder is a low temperature solder applied between the PCB portion and the base portion at 150 degrees C. or less.

9. The heat exchange arrangement of claim 1, wherein coolant flowing through the plurality of cooling channels directly contacts the second surface of the PCB portion.

10. The heat exchange arrangement of claim 1, wherein coolant flowing through the plurality of cooling channels removes heat generated by the plurality of LED arrays during operation.

11. A method of making a heat exchange arrangement for a light emitting diode (LED) lamp module, comprising:
providing a base portion having first and second surfaces, the first surface comprising a plurality of open channels disposed thereon;
providing a printed circuit board (PCB) portion having first and second surfaces, the first surface of the PCB having a plurality of LED arrays disposed thereon, the plurality of LED arrays forming a plurality of concentric arc-shaped LED arrays, the second surface of the PCB portion configured to be coupled to the first surface of the base portion; and
soldering the PCB portion to the base portion so that the second surface of the PCB portion encloses said plurality of open channels to form a plurality of cooling channels between the PCB portion and the base portion;
wherein the plurality of cooling channels are arc-shaped when viewed from above to conform to the plurality of concentric shaped LED arrays to follow a pattern of heating zones in the plurality of LED arrays so that consistent temperature is maintained in the plurality of LED arrays.

12. The method of claim 11, comprising coupling respective ends of the plurality of cooling channels to a respective plurality of coolant fluid inlets and coolant fluid outlets for passage of coolant fluid therethrough.

13. The method of claim 11, wherein the PCB portion comprises a metal plate.

14. The method of claim 13, wherein the metal plate is made from copper, aluminum, or combinations thereof.

15. The method of claim 11, wherein providing the base portion comprises machining the plurality of open channels into the base portion.

16. The method of claim 11, wherein soldering the PCB portion to the base portion comprises soldering the PCB portion to the base portion at 150 degrees C. or less.

17. A system for removing heat from a light emitting diode (LED) lamp module, comprising:
a base portion having first and second surfaces, the first surface comprising a plurality of open channels disposed thereon; and
a printed circuit board (PCB) portion having first and second surfaces, the first surface of the PCB having a plurality of LED arrays coupled thereto, the plurality of LED arrays forming a plurality of concentric arc-shaped LED arrays, the second surface of the PCB portion configured to be coupled to the first surface of the base portion;
wherein the second surface of the PCB portion is soldered to the base portion to encloses said plurality of open channels, thereby forming a plurality of cooling channels therebetween, the plurality of cooling channels comprising watertight passages for a coolant fluid to flow through; and
wherein the plurality of cooling channels are arc-shaped when viewed from above to conform to the plurality of concentric shaped LED arrays to follow a pattern of heating zones in the plurality of LED arrays so that consistent temperature is maintained in the plurality of LED arrays.

18. The system of claim 17, wherein the PCB portion comprises a metal plate made from copper, aluminum, or combinations thereof.

19. The system of claim 18, wherein the solder is a low temperature solder configured to be applied between the PCB portion and the base portion at 150 degrees C. or less.

20. The system of claim 17, wherein the coolant fluid flowing through the plurality of cooling channels is directly engageable with the second surface of the PCB portion.
